(19) United States
(12) Patent Application Publication
(10) Pub. No.: US 2021/0114931 A1
(43) Pub. Date: Apr. 22, 2021

(54) INTERFACE AGENTS FOR THE PREPARATION OF COLD ROAD SURFACINGS

(71) Applicant: RHODIA OPERATIONS, PARIS (FR)

(72) Inventors: Arnaud BOURDETTE, CHELLES (FR); Frédéric DELFOSSE, PESSAC (FR); Marie-Pierre LABEAU, SEVRES (FR); Thomas LEBARBE, AUDENGE (FR); Hélène MARTIN, CHATILLON (FR); Simon ROUSSEAU, TALENCE (FR); Pierre-Jean MERCIER, MARTILLAC (FR)

(73) Assignee: RHODIA OPERATIONS, PARIS (FR)

(21) Appl. No.: 16/608,721

(22) PCT Filed: Apr. 27, 2018
(86) PCT No.: PCT/EP2018/060853

§ 371 Date: Oct. 25, 2019

(30) Foreign Application Priority Data
Apr. 27, 2017 (FR) 1753687

(51) Int. Cl. C04B 26/26; C04B 24/04

(52) U.S. Cl. CPC C04B 26/26; C04B 2111/0075; C04B 24/045

(57) ABSTRACT

The invention relates to the manufacture of a bituminous product type mix or surface dressing which includes bringing into contact, at a temperature below 110° C., mineral particles with an emulsion (i) derived from emulsification of a hydrocarbon binder in an aqueous phase at a mixing temperature above the contacting temperature, and (ii) which includes an additive which:
forms a homogeneous mixture with the hydrocarbon binder at the mixing temperature;
is not compatible with the hydrocarbon binder at the contacting temperature;
is used at a content above its solubility in the aqueous medium of the emulsion at the contacting temperature.

The present invention pertains to the field of bituminous products, notably useful for the production of road surfacings, based on mineral particles made integral with each other by a hydrocarbon binder according to techniques where the hydrocarbon binder is brought into contact with mineral particles at low temperature, notably according to so-called cold techniques. More specifically, it relates to a method for manufacturing bituminous products at low temperature implementing specific additives in the hydrocarbon binder, leading to particularly interesting bituminous products.

In so-called “bituminous” products, mineral particles are bound together by a hydrocarbon binder, which covers all or part of their surface. This hydrocarbon binder is in general a bitumen (pure bitumen or bitumen modified by addition notably of polymer(s) or fluxing agents for example of petroleum or plant origin), a plant based binder (pure or modified) or a synthetic binder of petroleum origin and being able to contain, or not, a plant based part.

Different techniques for preparing bituminous products employing this type of hydrocarbon binder are known. When the particles are totally (or substantially totally) covered by the binder, this is known as a “coating” technique, which leads to a bituminous product known as a “mix”. Alternatively, it is also possible to make the particles integral without necessarily coating them totally, according to techniques where the particles are deposited on a hydrocarbon binder course, the formed product obtained being a “surface dressing” where the particles are only partially coated. Whether mixes or surface dressings, two major modes of preparation exist, according to techniques designated respectively “hot” and “cold”.

Hot techniques (which lead to bituminous products of so-called “hot” mixes or surface dressings) bring into contact aggregates (heated or not) with a hydrocarbon binder taken to a temperature above 110° C., typically around 140 to 160° C.

Hot bituminous products have in general good qualities in terms of bonding of the aggregates, workability and mechanical properties after application and cooling, with properties relatively easy to adapt by playing on the nature of the binder. That being said, they have drawbacks in terms of heating costs and, often, repercussions on the environment. For this reason, techniques at lower temperature have been developed, including notably so-called “cold” techniques.

The present invention focuses on these techniques for preparing bituminous products at low temperature, which include in particular so-called “cold” techniques.

In the sense of the present description, for reasons of brevity, “coating (total or partial) at low temperature” will designate a method where mineral particles and a binder are brought into contact at a temperature below 110° C. and generally below 100° C., typically less than or equal to 90° C., and more generally at 60° C. The bituminous products obtained according to these so-called low temperature coating techniques are either mixes in the proper sense when the coating is total, or surface dressings when it is partial. These bituminous products will be designated respectively in the present description by the terms “low temperature hydrocarbon mixes” and “low temperature hydrocarbon surface dressings” (or more simply “low temperature mixes (or surface dressings))”.

Low temperature coating techniques notably include “cold” techniques and notably the technique designated “cold coating”, where the coating is carried out without heating, and without drying of the aggregates, thus at a temperature close to ambient temperature, i.e. typically at temperatures between 5 and 50° C. as a function of the climatic conditions (advantageously between 10 and 40° C.). Low temperature coating techniques that do not meet this definition will be designated in the present description by “moderate temperature coating” techniques where the bringing into contact of the aggregates and the bitumen typically takes place at a temperature comprised, for example, between 40 and 110° C., typically with preheating of the hydrocarbon binder and/or drying and/or heating of particles before bringing them into contact.

Cold coating techniques lead to so-called “cold” bituminous products (namely mixes or surface dressings). The bituminous products obtained according to techniques designated herein moderate temperature coating techniques will be for their part designated by the so-called term “moderate temperature” bituminous products (namely mixes or surface dressings). In the sense of the present description, the use of the term “cold asphalt mix” will be reserved to designate a “asphalt mix produced from aggregates, a hydrocarbon binder and optionally dopes and/or additives, of which the characteristics enable coating without drying and heating of the aggregates”, which corresponds to the definition of the NF P 98-149 Standard (Terminologie de enrobes hydrocarbonées).

In low temperature coating techniques, not just cold but also moderate temperature coating techniques, the aggregates to coat are in general brought into contact at low temperature with a hydrocarbon binder in the form of an emulsion and the bituminous material is obtained by breaking the emulsion and progressive coalescence of the globules of hydrocarbon binder on all or part of the surface of the particles.

The behaviour of the binder following breakage has a consequent impact on the workability of the mixes obtained as well as on the compactibility properties of the mixes and surface dressings and on the final mechanical properties of the surfacing obtained. In the low temperature conditions used for the production of cold or moderate temperature mixes, the viscosity of the hydrocarbon binders can notably negatively impact the quality of the coating.

An aim of the present invention is to provide a method making it possible to improve the quality of bituminous products obtained by coating (total or partial) at low temperature of the aforesaid type.

To this end, the present invention proposes incorporating a particular additive in the hydrocarbon binder in low temperature coating techniques, namely a compound that can be solubilised hot in the hydrocarbon binder, but less soluble in the hydrocarbon binder during coating at low temperature, which makes it possible to modify the interface properties between the water and the bitumen.

More specifically, according to a first aspect, the subject matter of the present invention is a method for manufacturing a bituminous product which includes a step (E2) of bringing into contact mineral particles with an emulsion of hydrocarbon binder carried out at a contacting temperature (T2) below 110° C., where said emulsion is prepared according to a prior step of emulsification (E1) where, into an aqueous medium (M), is introduced a hydrocarbon binder including an additive (A) and brought to a mixing temperature T1 above the contacting temperature T2, said additive (A):
forming a homogeneous mixture with the hydrocarbon binder at the mixing temperature T1; and
being a compound not compatible with the hydrocarbon binder at the contacting temperature T2, typically incapable of solubilising the hydrocarbon binder at a rate of more than 5% by weight; and
being used at a content above its solubility in said aqueous medium (M) at the contacting temperature T2.

The works that have led to the present invention indicate that the use of the additive in the aforesaid conditions makes it possible to modify advantageously the interface between the particles of bitumen and the aqueous phase, which is likely to optimise breakage and coating (total or partial) of the particles.

In the method of the invention, the additive A is introduced beforehand into the hydrocarbon binder at a temperature at least equal to T1 then, in the emulsification step (E1), this hydrocarbon binder is introduced into the aqueous medium (M) at the temperature T1, temperature at which said binder is compatible with the additive (A) and forms a homogeneous mixture without dephasing.

At the temperature T1, the additive advantageously plays the role of fluxing agent of the bitumen. Next, the emulsion is employed in the step of bringing into contact mineral particles with an emulsion of hydrocarbon binder (E2), at a lower contacting temperature (T2), where the additive (A) is significantly less compatible with the hydrocarbon binder, which, schematically, forces the additive to be expulsed outside of the globules of bitumen of the emulsion.

The works of the Inventors seem to indicate that, in the conditions of the bringing into contact step (E2), and notably in so far as it is further used at a content above its solubility in water, the additive thereby expulsed by the hydrocarbon binder is found at least in part “blocked” at the interfaces between the aqueous medium and the hydrocarbon binder given its low compatibility in the two media. The additive then passes, schematically, from the status of fluxing agent of the hydrocarbon binder that it would ensure in step (E1) to that of interface agent. In practice, this passage usually takes place upstream of step (E2): during the reduction in temperature from T1 to T2, the emulsion passes in general through an intermediate temperature where the transition takes place.

The contacting temperature T2 to which reference is made in the present description is that of the emulsion at the moment of being brought into contact. In practice, the emulsion and the aggregates are at the same temperature T2 when they are brought into contact:

When the Bituminous Product Prepared According to Step (E2) is a Mix:

The contacting temperature T2 corresponds in general to the temperature of the aggregates (given the mass effect, the emulsion is taken to their temperature, namely to ambient temperature if the aggregates are not preheated, or alternatively to the temperature at which the aggregates are preheated, typically between 20 and 40° C.).

When the Bituminous Product Prepared According to Step (E2) is a Surface Dressing:

The contacting temperature T2 corresponds as a general rule to ambient temperature (for a surface dressing, the mix is placed in contact with the ground, and is thus brought to its temperature, before the deposition of the aggregates (gritting).

According to a particular aspect, the subject matter of the present invention is the use of additives A of the aforesaid type as interface agent in a method for preparing a bituminous product, notably intended for the production or the repair of a road surfacing.

The effect at the interfaces obtained before, during and/or after step (E2) is likely to modify the phenomena of coalescence between the globules of hydrocarbon binder. It seems in addition that the modifications that it induces at the interfaces are liable to improve the processes of drainage of water following breakage of the emulsion.

According to another particular aspect, the subject matter of the invention involves particular emulsions of the type described above and which are used in step (E2) where it seems that at least one part of the additive is found at the interface between the globules of bitumens and the aqueous phase.

Preferably, the additive A used according to the invention is a volatile compound, which evaporates out of the prepared bituminous product (after having ensured its double role of fluxing agent then of interface agent), this evaporation making it possible to obtain a low temperature coating of composition not modified by the additive.

The present invention proves to be especially interesting when the additive used includes at least one compound having the following formula (I):

R¹—X—R—Y—R² (I)

where:
R¹ is a methyl
R², identical or different to R¹, is a C₁-C₁₁, preferably C₁-C₉, more preferentially C₁-C₇, or even C₁-C₅ hydrocarbon chain (typically an alkyl), linear or branched,
each of —X— and —Y—, identical or different, is a —O—C(═O)— group; or a —C(═O)—O— group; or a —NR′—C(═O)— group; or a —C(═O)—NR′— group
   with R′ representing a hydrogen atom or instead a C₁-C₄ alkyl radical; and
—R— is a C₁-C₁₀ divalent hydrocarbon chain, linear or branched, and optionally interrupted by one or more oxygen atoms.

As additive A, it is possible to use according to the invention (i) a single compound having the formula (I) above, namely a single compound of formula CH₃—X—R—Y—R² with the R², X, Y and R groups having the above definitions; or instead, alternatively, (ii) a mixture of several compounds of formula CH₃—X—R—Y—R² with several types of R², X, Y and R groups having the above definitions.

It is possible, according to a particular embodiment, to use as additive (A) a mixture including one or more compounds of formula (I) according to the invention with other compounds, provided that said mixture meets the criteria required for an additive (A) according to the invention in terms of compatibility with the bitumen (at the temperatures T1 and T2) and the aqueous medium (at the temperature T2). Provided that this condition is met, it is possible for example to use as additive A a mixture including at least one compound (I) according to the invention and at least one compound of formula Alk-X—R—Y—R² where Alk- designates a C₁-C₁₁, preferably C₁-C₉, hydrocarbon chain (typically an alkyl), linear or branched, and X, Y and R meet the definitions given above for these groups in the compounds of formula (I).

Different aspects of the invention and embodiments that may be envisaged of the invention are described in greater detail hereafter.

### Mineral Particles

The mineral particles employed in step (E2) of the method of the invention are solid particles which may be selected from all those that can be used for the production of bituminous products, notably for road construction.

As an example of mineral particles that can be used in step (E2) in the case of the production of a mix, it is notably possible to cite natural mineral aggregates (chippings, sand, fines) derived from quarries or gravel pits, recycling products such as aggregates of mixes resulting from the recycling of materials recovered during road repairs as well as surplus from coating plants, manufacturing rejects, “shingles” (derived from the recycling of roof membranes), aggregates derived from the recycling of road materials including concretes, slags in particular cinders, schists in particular bauxite or corundum, rubber crumbs derived from the recycling of tyres notably, artificial aggregates of any origin and derived for example from municipal solid waste incineration (MSWI) bottom ash, as well as mixtures thereof in all proportions.

In step (E2), it is possible to use untreated mineral particles or instead mineral particles of which a part has been subjected to a coating before the coating of step (E2). For example, it is possible to use in step (E2) natural aggregates of which a part only has been coated beforehand by a hydrocarbon binder (for example mineral aggregates of which all or part of the d/D mineral fraction has been subjected beforehand to a coating step.

Natural mineral aggregates typically include:
elements below 0.063 mm (filler or fines)
sand of which the elements are comprised between 0.063 mm and 2 mm;
chippings, of which the elements have dimensions
comprised between 2 mm and 6 mm;
greater than 6 mm;

The size of the mineral aggregates is measured by the tests described in the NF EN 933-2 Standard (version May 1996).

“Aggregates of mixes” are taken to mean mixtures of aggregates and bituminous binders derived from the milling of mix courses, crushing of slabs extracted from roads made of mixes, pieces of slabs of mixes, mix wastes or production surpluses of mixes (production surpluses are materials coated or partially coated in coating plants resulting from transitory manufacturing phases). These elements and the other recycling products can reach dimensions up to 31.5 mm.

“Mineral particles” of the type employed in step (E2) are also designated by the term “O/D mineral fraction”. This 0/D mineral fraction may be separated into two particle sizes: the 0/d mineral fraction and the d/D mineral fraction.

The finest elements (the Old mineral fraction) will be those comprised within the range between 0 and a maximum diameter that can be fixed between 2 and 6 mm (0/2 to 0/6), advantageously between 2 and 4 mm. The other elements (minimum diameter greater than 2, 3, 4, 5 or 6 mm; and around up to 31.5 mm) constitute the d/D mineral fraction.

As an example of mineral particles that can be used in step (E2) in the case of the production of a surface dressing, it is possible notably to cite natural mineral aggregates (chippings, sand, fines) derived from quarries or gravel pits, slags in particular cinders, schists in particular bauxite or corundum, artificial aggregates of any origin and derived for example from municipal solid waste incineration (MSWI) bottom ash, as well as mixtures thereof in all proportions.

### Hydrocarbon Binder and the Emulsion Prepared in Step (E1)

In the sense of the present description, “hydrocarbon binder” (also designated in a more concise manner as “binder”) is taken to mean any hydrocarbon compound of fossil or plant origin that can be used for the production of bituminous products, this hydrocarbon binder which can for example be a bitumen, a plant based binder or a synthetic binder of petroleum origin, and which can, independently of its nature, be pure or modified, notably by addition of dopes or polymer(s).

The binder used according to the present invention may moreover be a soft to hard binder, advantageously a grade ranging from 10/20 to 160/220.

According to an interesting embodiment, the binder is a bitumen, pure or modified by polymers. The “polymer” modifying the bitumen to which reference is made herein may be selected from natural or synthetic polymers. It is for example a polymer of the family of elastomers, synthetic or natural, and in an indicative and non-limiting manner:
random, multi-sequenced or star-shaped copolymers, of styrene and butadiene or isoprene in all proportions (in particular block copolymers of styrene-butadiene-styrene (SBS), styrene-butadiene (SB, also called “SBR” for “styrene-butadiene rubber”), styrene-isoprene-styrene (SIS)) or copolymers of the same chemical family (isoprene, natural rubber, etc.), optionally cross-linked in situ,
copolymers of vinyl acetate and ethylene in all proportions,
copolymers of ethylene and esters of acrylic acid, methacrylic acid or maleic anhydride, copolymers and terpolymers of ethylene and glycidyl methacrylate) and polyolefins.

The polymer modifying the bitumen may be selected from recovered polymers, for example “rubber crumbs” or other rubber based compositions reduced into bits or into powder, for example obtained from used tyres or other polymer-based wastes (cables, packaging, agricultural waste, etc.) or instead any other polymer commonly used for modification of bitumens such as those cited in the Technical Guide by the Permanent International Association of Road Congresses (PIARC) and edited by the Laboratoire Central des Ponts and Chauss\tilde{e}es “Use of Modified Bituminous Binders, Special Bitumens and Bitumens with Additives in Road Pavements” (Paris, LCPC, 1999), as well as any mixture in all proportions of these polymers.

Independently of its exact nature, the binder used in step (E2) is specifically in the form of an emulsion prepared in step (E1), namely a dispersion of the binder in the aqueous medium (M) which plays the role of continuous phase of the emulsion (emulsion of bitumen when the binder is a bitumen).

The aqueous phase (M) implemented in the method of the invention to produce the hydrocarbon binder emulsion is typically water, but the method is not limited to this single embodiment. Typically, the aqueous phase (M) employed within the scope of the invention includes at least 50% by weight of water compared to the total weight of the aqueous phase, and usually at least 80%, or even at least 90% by weight of water compared to the total weight of the aqueous phase. Usually, water is substantially the only hydrophilic solvent present in the aqueous phase and it represents typically between 95 and 100% by weight of the totality of the hydrophilic solvents present.

Although this is not systematically required, the emulsion prepared in step (E1) usually contains a surfactant or a mixture of surfactants, which notably makes it possible to stabilise the emulsion and/or help the dispersion of the hydrocarbon binder in the aqueous medium (M). In this context, for a given hydrocarbon binder, it is possible to use during step (E1) any surfactant or emulsifier suited to the emulsification and to the stabilisation of the dispersion of the targeted hydrocarbon binder, surfactants of this type being well known per se by those skilled in the art.

During the manufacture of the emulsion during step (E1), the binder is typically dispersed in the form of fine droplets (globules) in water for example by a mechanical action, the addition of surfactant being able to help this process (the surfactant typically forms a sort of protective film around the droplets, preventing them from agglomerating and thereby making it possible to maintain the mixture stable and to store it for a certain time). The quantity and the type of surfactant added to the mixture determine the stability of the emulsion during storage and have an influence on the curing time at the moment of laying.

When a surfactant is used, it may be positively charged (cationic surfactant), negatively charged (anionic surfactant), or instead it may be an amphoteric or zwitterionic surfactant, or a non-ionic surfactant. These surfactants may be of petroleum, plant and/or animal origin (for example it is possible to use surfactants of plant and petroleum origin). The surfactant may be an alkaline soap of fatty acids: sodium or potassium salts of an organic acid (resin for example). The emulsion prepared is then a so-called anionic emulsion. The surfactant may conversely be an acid soap, which is generally obtained by action of hydrochloric acid on one or two amines. The emulsion is then a so-called cationic emulsion. Among surfactants relevant in road applications may be cited: the surfactants sold by Akzo NOBEL (Redicote® E9, Redicote® EM 44, Redicote® EM 76), the surfactants sold by CECA (Dinoram® S, Polyram® S, Polyram® L 80), the surfactants sold by Meadwestvaco (Indulin® R33, Indulin® R66, Indulin® W5). One or more of these surfactants, alone or in mixtures, could be used.

The emulsion formed in step (E1) can be in all or part in the form of a foam. Such a foam may for example be formed when the hydrocarbon binder and the aqueous medium are mixed according to a method for injecting the aqueous phase (optionally with air) in a flow of binder.

The emulsion formed in step (E1) is typically conducted by mixing the hydrocarbon binder taken to the mixing temperature T1 in the aqueous phase generally at a temperature below T1 (the aqueous phase is generally heated prior to the emulsification but not up to T1 in the majority of cases). The mixing temperature T1 to which the hydrocarbon binder is taken just before bringing it into contact with the aqueous medium (M) is typically above 110° C., or even 120° C. and it is in general between 125 and 160° C., notably between 130 and 150° C.

The emulsion formed in step (E1) may optionally include (in addition to the aqueous phase, bitumen including the additive A, and optional surfactants) one or more other additives commonly used in this type of emulsion, notably those used in the road field, such as compositions based on rubber reduced into powder (rubber crumbs), plant based waxes or waxes of petrochemical origin, or adhesiveness dopes.

Furthermore, the hydrocarbon binder emulsion formed in step (E1) may optionally contain a latex, synthetic or natural. Latex is taken to mean a dispersion of polymers (polyisoprene, SBS, SB, SBR, acrylic polymers, etc.), cross-linked or not, in the aqueous phase of the emulsion. This latex is then typically incorporated in the aqueous phase before emulsification or on-line during the manufacture of the emulsion, or instead after dispersion of the binder in the aqueous medium (M).

### Additive A

The nature of the additive A used according to the invention can vary to a very large extent provided that this additive meets the following two criteria in terms of compatibility with the hydrocarbon binder implemented in the method:
the additive A forms a homogeneous mixture, namely without phase separation, with the hydrocarbon binder at the mixing temperature T1 of step (E1);
and
the additive A is much less compatible with the hydrocarbon binder at the contacting temperature T2 of step (E2)

It is preferred that the additive A is the least compatible possible in the hydrocarbon binder at the contacting temperature T2 of step (E2). Typically, the hydrocarbon binder is soluble at less than 5% by weight, or even less than 4% by weight, in the additive A at the contacting temperature T2.

The solubility of a bitumen hydrocarbon binder in a given additive may be evaluated by measuring the quantity of hydrocarbon binder passed into solution in the additive after 3 days of immersion at ambient temperature.

Furthermore, the additive A is specifically used in the method of the invention at a content above its solubility in said aqueous medium (M) at the contacting temperature T2. By this is meant that the quantity of additive A present in the emulsion at the temperature T2 outside of the particles of hydrocarbon binder (that is to say, schematically the quantity of additive A released by the hydrocarbon binder given the decrease in temperature) is above the quantity of additive (A) that the aqueous medium can solubilise. For a given additive, knowing its solubility in the aqueous medium and in the hydrocarbon binder (which can be determined experimentally), it is within the competence of those skilled in the art to adapt the quantity of additive A to implement in the method.

According to a possible embodiment, it is optionally possible to carry out the emulsification of step (E1) with both the additive A in the bituminous binder and also in an aqueous medium in such a way as to ensure that the additive A will be present beyond its limit of solubility in the aqueous medium in step (E1). A possible embodiment in this respect, although not very interesting a priori from an economic viewpoint, consists in carrying out the emulsification of a hydrocarbon binder including the additive A solubilised in an aqueous medium saturated with said additive A.

Furthermore, the additive A used according to the invention is preferably a volatile compound at ambient temperature, which is preferably eliminated rapidly from the bituminous products prepared according to the method of the invention.

Compounds of Formula (I) that can be Used According to the Invention

As very suitable additives A according to the invention, it is possible in particular to use compounds of formula (I) defined above in the present description, namely compounds or mixtures of compounds of formula CH₃—X—R—Y—R², where the R², —X—, —Y—, and —R— groups have the aforesaid significations.

It is possible to use according to the invention either a single type of compound (I), or, alternatively, a mixture including different compounds having the formula (I). In the application, unless explicitly stated, the notion of compound of formula (I) used in the singular or in the plural is taken to target not just the embodiment where a single type of compound having the formula (I) is used but also that where a mixture of several types of compounds having the formula (I) is implemented.

The compounds of formula (I) advantageously have a molecular weight comprised between 130 g/mol and 290 g/mol, more advantageously comprised between 140 g/mol and 250 g/mol, even more advantageously comprised between 150 g/mol and 200 g/mol.

In the compounds of formula (I) used according to the invention, the total number of carbon atoms is preferably comprised between 5 and 12. According to an embodiment, the total number of carbon atoms is greater than or equal to 6. Furthermore, in general it is preferred that the total number of carbon atoms is less than or equal to 11, for example less than or equal to 10. Thus, for example, the total number of carbon atoms may be comprised between 6 and 11, for example between 6 and 8.

The total number of carbon atoms defined in the preceding paragraph is in particular valid when the R, R¹ and R² groups are saturated groups, linear or branched.

The R² group advantageously represents a C₁-C₁₁, typically C₁-C₉, alkyl, aryl, alkylaryl, or arylalkyl group, linear or branched, cyclic or non-cyclic, saturated or unsaturated and usually saturated,

The R² group may notably be a methyl, ethyl, n-propyl, isopropyl, benzyl, phenyl, n-butyl, isobutyl, n-pentyl, isoamyl, cyclohexyl, hexyl, n-hexyl, heptyl, isooctyl, 2-ethylhexyl, 2-propylhexyl group. At least one of R¹, R² is a methyl radical.

Advantageously, (notably for reasons of ease of synthesis) R¹, R² both represent a methyl radical and the compound of formula (I) is then a dimethyl compound that then has the following formula (Ia):

CH₃—X—R—Y—CH₃ (Ia)

where the —X—, —Y—, and —R— groups have the aforesaid significations.

According to a first interesting alternative, a compound of formula (I) according to the invention may for example be a compound of formula (Ia) selected from dimethyl adipate, dimethyl glutarate, dimethyl succinate, and mixtures thereof.

A suitable mixture according to this alternative may for example include, by weight compared to the total weight of the mixture (measurable for example by gas phase chromatography), a mixture of dimethyl adipate (for example 4 to 22% by weight), dimethyl glutarate (for example 55 to 77% by weight), and dimethyl succinate (for example 12 to 32% by weight).

It is possible for example to use as compound (I), according to the first alternative, the solvent sold by Solvay under the denomination Rhodiasolv® RPDE.

Advantageously, the additive available from Solvay under the trade name INNROAD® BOOST (additive compatible hot with the bitumen and solubilising the bitumen at a rate of less than 2% at ambient temperature after three days) could be used.

According to a second possible alternative, another compound of formula (I) that can be envisaged, which can be used alone or in a mixture with that of the first alternative, is a compound of formula (Ia) and the R group is selected from the following groups:
the R_{MG} group of formula —CH(CH₃)—CH₂—CH₂—,
the R_{ES} group of formula —CH(C₂H₅)—CH₂—, and
mixtures thereof.
   —X— and —Y— are advantageously esters,
   preferably esters of diacids
   (compounds where —X—═—O—C(═O)—; and —Y—═—C(═O)—O—,
   namely of formula: CH₃—O—C(═O)—R—C(═O)—R²); or instead
   esters of diols (where —X—═—C(═O)—O— and —Y—═—O—C(═O)—
   namely of formula: CH₃—C(═O)—O—R—O—C(═O)—R²).

It is possible to use for example, according to this second alternative, the solvent sold by Solvay under the denomination Rhodiasolv® IRIS (which is compatible hot with the bitumen and solubilises it at a rate of less than 3% at ambient temperature after three days).

According to a possible embodiment, the additive A may be a mixture, meeting the criteria required for an additive (A) according to the invention in terms of compatibility with the hydrocarbon binder (at T1 and T2) and with the aqueous medium (at T2) and including:
one or more of the preceding compounds of formula (I), notably compounds of formula (I) according to the first and the second alternatives defined in the paragraphs above; and
one or more compounds having the following formula (II):

R¹—X—R—Y—R² (II)
where:
   R¹ is a C₂-C₁₁, preferably C₂-C₉, hydrocarbon chain (typically an alkyl), linear or branched, advantageously a C₂-C₁₁, typically C₂-C₉, alkyl, aryl, alkylaryl, or arylalkyl group, linear or branched, cyclic or non-cyclic, saturated or unsaturated and usually saturated,
   X—, —Y—, —R—, and R² have the aforesaid significations given for the compound of formula (I)

When this type of mixture is used, the compounds of formula (I) are in general used in a majority and the weight ratio (I)/(II) of the total weight of compound(s) of formula (I) compared to the total weight of compound(s) of formula (II) is usually greater than or equal to 1, for example greater than or equal to 2.

In the compounds of formula (II) optionally used according to the invention, the total number of carbon atoms is preferably comprised between 7 and 16. According to an embodiment, the total number of carbon atoms is greater than or equal to 8, or even greater than or equal to 9. Furthermore, in general it is preferred that the total number of carbon atoms is less than or equal to 15, for example less than or equal to 14. Thus, for example, the total number of carbon atoms may be comprised between 8 and 15, for example between 8 and 12 or between 10 and 15 or between 10 and 12 or between 12 and 14.

The total number of carbon atoms defined in the preceding paragraph is in particular valid when the R, R¹ and R² groups are saturated groups, linear or branched, and notably when they are saturated and branched groups.

In compounds of formula (II) optionally implemented according to the invention, the R¹ and R² groups may notably be selected from ethyl, n-propyl, isopropyl, benzyl, phenyl, n-butyl, isobutyl, n-pentyl, isoamyl, cyclohexyl, hexyl, n-hexyl, heptyl, isooctyl, 2-ethylhexyl, 2-propylhexyl groups. Typically, (notably for reasons of ease of synthesis) R¹ and R² are identical and are selected from ethyl, n-propyl, isopropyl, n-butyl, isobutyl, n-pentyl, isoamyl, in particular ethyl or isobutyl groups.

It is possible to use as compounds of formula (II) compounds in which R is such as defined in one of the following embodiments, or a mixture of compound(s) according to these embodiments:
Embodiment 1: R is a radical of formula —(CH₂)ᵣ—, where r is an average number comprised between 2 and 8 included. In particular, R is a radical of formula —(CH₂)ᵣ—, where r is an average number comprised between 2 and 4 included.
Preferably, R is selected such that the compound may be a mixture of derivative of adipate (r=4), derivative of glutarate (r=3), and derivative of succinate (r=2).
Embodiment 2: R is a branched C₃-C₁₀ alkanediyl radical. R may notably be a C₃, C₄, C₅, C₆, C₇, C₈, C₉ group, or a mixture. It is preferably a C₄ group.
The R group is preferably selected from the following groups:
   the R_{MG} group of formula —CH(CH₃)—CH₂—CH₂—,
   the R_{ES} group of formula —CH(C₂H₅)—CH₂—, and
   mixtures thereof.
Such mixtures, as well as appropriate methods for obtaining them are notably described in the documents WO 2007/101929; WO 2007/141404; WO 2008/009792; WO 2008/062058.
Embodiment 3: R is a C₂-C₈, advantageously C₂-C₄, alkenediyl radical, linear or branched.
The R group is preferably selected from the following groups:
   the group of formula —CH═CH—, the double bond being of Z configuration
   the group of formula —CH═CH—, the double bond being of E configuration
   the group of formula —CH(CH₂)—CH₂—, and
   mixtures thereof.
Embodiment 4: R is a —(OE/OP)ₙ- radical where OE/OP are alkoxy groups, preferably selected from ethoxy, propoxy groups and ethoxy/propoxy mixtures and n an average number comprised between 1 and 5 included and with a total number of carbons of 10 in the R group.

Notably in the aforesaid embodiments 1 to 4, X and Y are advantageously esters, preferably esters of diacids (where: —X—═—O—C(═O)—; and Y═—C(═O)—O—) or esters of diols (where: —X—═—C(═O)—O— and Y═—O—C(═O)—)

Advantageously, when a compound of formula (II) according to the invention is used, this compound (II) is selected from:
diisobutyl adipate, diisobutyl glutarate or diisobutyl succinate, and mixtures thereof, such as for example:
   a mixture including, by weight compared to the total weight of the mixture (measurable by gas phase chromatography): 5 to 29% by weight of diisobutyl adipate; 50 to 72% by weight of diisobutyl glutarate; and 10 to 32% by weight of diisobutyl succinate.
   the solvent sold by Solvay under the denomination Rhodiasolv® DIB (as an example, a mixture 1:1 by weight of INNROAD® Boost and Rhodiasolv® DIB is compatible hot with the bitumen and solubilises it at a rate of less than 4% at ambient temperature after three days).
diethyl adipate, diethyl glutarate or diethyl succinate, and mixtures thereof, such as for example:
   a mixture including, by weight compared to the total weight of the mixture (measurable by gas phase chromatography): 4 to 26% by weight of diethyl adipate; 52 to 77% by weight of diethyl glutarate; and 12 to 32% by weight of diethyl succinate.
   the additive available from Solvay under the name INNROAD® Protect

### Bituminous Products Accessible According to the Invention

The bituminous product that the method of the invention makes it possible to prepare include all bituminous products that can be produced at low temperature and notably cold, that is to say all bituminous products of type coated at low temperature according to the present description, including cold mixes and surface dressings and moderate temperature mixes and surface dressings.

The bituminous products accessible according to the invention include in particular dressings in emulsion and cold mixes notably of cold poured bituminous materials type, bituminous concretes in emulsion and storable mixes in emulsion, which are described in greater detail hereafter.

### Surface Dressings

A surface dressing is typically a course constituted of superimposed states of a hydrocarbon binder and solid mineral particles. It is typically obtained by spraying a hydrocarbon binder then by spreading on this binder solid mineral particles, in one or more layers. The whole is next compacted.

The solid mineral particles used in a surface dressing advantageously belong to the following granular (d/D) classes: 4/6.3, 6.3/10, 10/14.

The total hydrocarbon binder content in a surface dressing will be adapted as a function of the structure of the surface dressing (mono- or bi-course, type of chippings), the nature of the binder, climatic conditions and the dimension of the aggregates, following for example the recommendations of the document “Enduits superficiels d'usure—Guide technique, mai 1995”.

The hydrocarbon binder employed for the manufacture of a surface dressing may be a pure bitumen or a bitumen modified by polymers, such as described previously.

The hydrocarbon binder is a binder in emulsion. In this embodiment, the hydrocarbon binder advantageously includes, compared to the total weight of hydrocarbon binder, 0.1 to 10% by weight of said compound of formula (I), more advantageously 0.5 to 8% by weight, even more advantageously 1 to 6% by weight.

### Mixes:

Cold Poured Bituminous Materials

Cold poured bituminous materials are mixes for surface courses constituted of non-dried aggregates mixed in an emulsion of bitumen and poured in place continuously by means of specific equipment.

After application and breakage of the emulsion, this surfacing, cold poured at very low thickness (generally from 6 to 13 mm of thickness per course), has to reach its definitive consistency (rise in cohesion) very quickly. The additives used according to the invention can favourably influence this parameter.

For a cold poured bituminous material, the droplets of bitumen initially separated confer on the system a fluid character and an easy placement using specific machines for cold-poured bituminous materials. The system is then viscous. The characteristic time during which this state lasts is called the workability time. Secondly, the droplets of bitumen coalesce and form a gel. When all the droplets of bitumen are grouped together, it is considered that the emulsion has broken (breakage time). The system is then viscoelastic. The system tends thereafter to contract so as to reduce the contact surface between the water and the bitumen (cohesion time). This process follows a kinetic that will depend on the electrostatic repulsions between droplets and thus the nature of the bitumen and the emulsifier. The kinetic of the coalescence reaction between droplets of bitumen, linked at least in part to the physics-chemistry of the interfaces, conditions the speed of the rise in cohesion of the cold poured bituminous material, which can result in a sensitivity or not of the material to ageing conditions at young age.

Bituminous Concretes in Emulsion

Bituminous concretes in emulsion are asphalt mixes produced from aggregates and a hydrocarbon binder in emulsion. The aggregates may be used without prior drying and heating or undergo partial hot pre-lacquering. It may sometimes be necessary to reheat the product after its manufacture, during its application.

The hydrocarbon binder employed for the synthesis of bituminous concretes in emulsion is in the form of a binder in emulsion. The total content of hydrocarbon binder in said emulsion is typically 2 to 8 ppc (parts percent by weight), advantageously 3 to 7 ppc, more advantageously 3.5 to 5.5 ppc, compared to the weight of solid mineral particles. This binder content corresponds to the quantity of binder introduced as such (added binder) plus the quantity of binder recovered from aggregates of mixes forming part of the solid mineral fraction.

The hydrocarbon binder in an emulsion used for the confection of a bituminous concrete in emulsion advantageously includes, compared to the total weight of the hydrocarbon binder, 1 to 25% by weight of said compound of formula (I), more advantageously 2 to 15% by weight, even more advantageously 2 to 10% by weight, even more advantageously 3 to 10% by weight.

The bituminous concretes obtained according to the invention in emulsion may be used for the manufacture of storable mixes.

In this embodiment, the hydrocarbon binder advantageously includes, compared to the total weight of hydrocarbon binder, 10 to 30% by weight of said compound of formula (I), more advantageously 15 to 25% by weight, even more advantageously 17 to 22% by weight.

1.-10. (canceled)

11. A method for manufacturing a bituminous product comprising:
a step (E1) of forming an emulsion comprising a hydrocarbon binder, an additive and an aqueous medium, wherein forming the emulsion comprises introducing the hydrocarbon binder including the additive into the aqueous medium at a mixing temperature T1; and then
a step (E2) of contacting mineral particles with the emulsion at a contacting temperature T2 to form the bituminous product, the contacting temperature T2 being lower than the mixing temperature T1, the contacting temperature T2 being below 110° C.;
wherein:
the additive forms a homogeneous mixture with the hydrocarbon binder at the mixing temperature T1,
the additive is insoluble or soluble at a rate of 5% by weight or less in the hydrocarbon binder at the contacting temperature T2, and
a content of the additive in the emulsion is greater than a solubility of the additive in the aqueous medium at the contacting temperature T2.

12. The method of claim 11, wherein the additive comprises a volatile compound, and further comprises evaporating the additive from the bituminous product.

13. The method of claim 11, wherein the additive comprises a compound having the following formula (I):
R¹—X—R—Y—R² (I)
where:
R¹ is a methyl
R², identical or different to R¹, is a C₁-C₁₁, preferably C₁-C₉, hydrocarbon chain, linear or branched;
each of —X— and —Y—, identical or different, is a —O—(C═O)— group; or a —C(═O)—O— group; or a —NR′—C(═O)— group; or a —C(═O)—NR′— group
with R′ representing a hydrogen atom or instead a C₁-C₄ alkyl radical;
and
—R— is a C₁-C₁₀ divalent hydrocarbon chain, linear or branched, and optionally interrupted by one or more oxygen atoms.

14. The method of claim 13, wherein the additive comprises a compound or a mixture of compounds having the formula (I).

15. The method of claim 13, wherein the additive comprises a dimethyl compound having the following formula (Ia):
CH₃—X—R—Y—CH₃ (Ia)
where —X—, —Y—, and —R— have the significations given in claim 13.

16. The method of claim 15, wherein the additive comprises a compound or a mixture of compounds having the formula (Ia) selected from dimethyl adipate, dimethyl glutarate, and dimethyl succinate.

17. The method of claim 15, wherein the additive A is a compound of formula (Ia), where the R group is selected from the following groups:
the R_{MG} group of formula —CH(CH₃)—CH₂—CH₂—,
the R_{ES} group of formula —CH(C₂H₅)—CH₂—, and
mixtures thereof.

18. The method of claim 17, wherein the additive is a compound of formula (Ia), wherein X and Y are esters.

19. The method of claim 11, wherein the additive (A) is an interfacing agent at contacting temperature T2, and further comprises expulsing at least one part of said additive outside of hydrocarbon binder of the emulsion to be placed at an interface between the aqueous medium and the hydrocarbon binder.

20. An emulsion, comprising:
a hydrocarbon binder,
an additive (A), and
an aqueous medium,
wherein at least one part of the additive (A) is present at the interface between globules of the hydrocarbon binder and the aqueous phase.

21. The emulsion of claim 20, wherein the additive comprises a compound having the following formula (I):
R¹—X—R—Y—R² (I)
where:
R¹ is a methyl
R², identical or different to R¹, is a C₁-C₁₁, preferably C₁-C₉, hydrocarbon chain, linear or branched;
each of —X— and —Y—, identical or different, is a —O—(C═O)— group; or a —C(═O)—O— group; or a —NR′—C(═O)— group; or a —C(═O)—NR′— group
with R′ representing a hydrogen atom or instead a C₁-C₄ alkyl radical; and
—R— is a C₁-C₁₀ divalent hydrocarbon chain, linear or branched, and optionally interrupted by one or more oxygen atoms.
